(19) United States
(12) Patent Application Publication
(10) Pub. No.: US 2012/0091214 A1
(43) Pub. Date: Apr. 19, 2012

(54) Controller for recreational-vehicle heating system

(76) Inventor: James M. Rixen, Sandy, OR (US)

(21) Appl. No.: 11/707,633

(22) Filed: Feb. 16, 2007

Related U.S. Application Data
(63) Continuation-in-part of application No. 10/421,365, filed on Apr. 22, 2003, now Pat. No. 7,284,710.
(60) Provisional application No. 60/774,481, filed on Feb. 16, 2006.

(51) Int. Cl. B60H 1/02; F24D 3/08; B60H 1/22

(52) U.S. Cl. 237/5; 237/12.3 B; 237/34; 237/81; 165/11.1

(57) ABSTRACT

A controller in a heat management system is capable of managing unlimited hydronic heat sources and unlimited heating zones, each located within a desired area and each controlled by temperature sensors in bi-directional electronic/electrical communication with the controller. A user interface can be included with the controller (or interact with the controller) and be in bi-directional electrical/electronic communication with the controller. In such a way, one or more users can manage the heating of domestic water and the heating of zones or areas in which the one or more users live via the controller. The controller in the heat management system may be used for controlling hydronic heating systems installed in RV, marine and home applications.

### CROSS REFERENCE TO RELATED APPLICATIONS

This application claims the benefit of Rixen, U.S. Provisional Patent Application No. 60/774,481, entitled “CONTROLLER FOR RECREATIONAL-VEHICLE HEATING SYSTEM” filed Feb. 16, 2006, which is hereby incorporated by reference herein. This application is a continuation-in-part of Rixen, et al. U.S. patent application Ser. No. 10/421,365, entitled “HEATING SYSTEM,” filed Apr. 22, 2003, which is hereby incorporated by reference herein.

### FIELD OF THE INVENTION

The present invention relates generally to heating systems for recreational vehicles, and more specifically, to a controller for recreational-vehicle heating systems.

### BACKGROUND OF THE INVENTION

Heating systems for campers and recreational vehicles are widely known. Conventional water heating systems for recreational vehicles generally fall into two classes. The first class includes systems that have a heating element(s) that extends into a cavity that holds several gallons of water. The heating element ultimately heats the entire volume of water in the cavity. Drawbacks to this first class include a lack of continuous hot water. In addition, the first class of systems takes a relatively long period of time to heat water. The second class involves systems that heat a relatively small volume of water with a gas or electric heating device. Conventional systems of the second class include propane, or other open flame “flash furnace” heating systems that directly heat domestic water supplied to the system. Open-flame systems like these are relatively expensive and relatively unsafe when used in a recreation vehicle. In addition, a propane system is ineffective to provide a constant supply of hot water.

### SUMMARY OF THE INVENTION

The controller of the present invention can be used with any conventional recreational-vehicle heating system (the “RV-heating system”), but preferably uses the one described in the following pending U.S. nonprovisional patent applications: Ser. No. 10/421,365 for an invention entitled HEATING SYSTEM and Ser. No. 60/380,586 for an invention entitled HEATING SYSTEM. The controller described in this application is intended to replace and/or augment the controller described in the pending applications.

The heating system in the above mentioned patent applications includes several features that incorporate use of the controller of the present invention and can allow the user to be informed about the status of the system and its components, including: (i) a detector to inform the user about the status of an electric back-up heater; (ii) independent controls for each heat source of the system; (iii) a control panel coupled to the system for remote positioning therefrom, and equipped with actuators necessary for controlling all heat sources of the system; (iv) a text-display capability for displaying at the control panel messages informing the user about the status of components of the system including the heating sources, temperature of the heating solution (preferably glycol), the temperature of hot water, and status of the fans located in areas desired to be heated such as cabins of a recreational vehicle; and (v) refill and service warning indicators displayable at the control panel to inform the user if one of the system fluids needs to be refilled or if the system requires service (based upon preselected criteria such as passage of time, fault detection of a system component(s).

Additional status-communication features include: (i) display of fault codes associated with a diesel-fired heater of the system both as a flashing LED display coupled to the actuator of that heater, and a textual message displayable simultaneously on the control panel; (ii) fluid-level sensors that monitor the fluid level of the heating solution contained in an expansion tank and provide information to control circuitry of the system to stop all system heating sources if the fluid level of the heating solution falls below a preselected threshold.

The heating system also includes several programmable features preferably achieved using software incorporated within the controller of the present invention so that each can be adjusted without requiring new hardware, and those features include: (i) a water-heating cycling feature that maximizes the capability and efficiency of the system heat sources by using plural heating solution temperature ranges for automatic actuation/de-actuation of each system heat source depending upon whether the user demands domestic hot water (e.g. system heat source(s) are actuated if water temperature falls below 150° F. and de-actuated if heating solution temperature reaches 180° F.) or area heating (without demand for domestic hot water)(e.g. system heat source(s) are actuated if heating solution temperature falls below 120° F. and de-actuated if heating solution temperature reaches 180° F.), (ii) a heat source priority controller governing situations when different ones of the heating sources of the system are actuated depending upon pre-selected factors such as heating source availability, user-demand requirements, etc.; (iii) an engine preheat loop that allows bi-directional heat transfer from and to the engine to allow for various engine situations such as vehicle-engine applications (RV and marine) as well as home-heating engine applications affording the capability to deice a driveway; (iv) a time-based de-actuator feature that disables an engine-preheat pump after a preset period of time to avoid undesired drainage of associated engine batteries and excessive wear of the pump

The controller (also referred to herein as control structure or control board) of the present invention and of the heating system previously described can be constructed to control and direct the flow of the heating solution through plural preselected loops such as a short loop supporting demand for hot domestic water but not heat (summer applications) and a long loop supporting demand for both hot domestic water and heat (winter applications). The controller can also be constructed to optimize heating efficiency and cost by having the capability of sensing whether any thermostat of the system becomes active, and responding to such sensing by activating a by-pass solenoid (that may be plural-way including two- or three-way) that allows the heating solution to circulate through the long loop.

The controller can also be programmable for automatic actuation/de-actuation of heating-area fans (such as cabin fans) when system heating solution temperature is over preselected minimum such as 110° F. (actuation) or under a preselected maximum such as 110° F. (de-actuation), when circulating water pumps, and for by-pass of the long loop solenoid if heat is unavailable. The heating system can include a set of temperature sensors that allow the control board to determine when heat is available from system heat sources and to determine when the cabin fans, circulating water pumps and by-pass solenoids are deactivated or activated.

### BRIEF DESCRIPTION OF THE DRAWINGS

FIG. 1 is a schematic flow diagram of a heating system utilizing a controller according to one embodiment of the present invention.

FIG. 2 is a schematic flow diagram of a heating system for RV and marine applications which can utilize the controller of the present invention.

FIG. 3 is a schematic flow diagram of a heating system for residential-home applications which can utilize the controller of the present invention.

FIG. 4 is a schematic diagram of a hydronic heating subsystem utilizing the controller of the present invention.

FIG. 5 is a schematic diagram of a control board cover that forms part of the controller of the present invention.

FIG. 6 is a schematic diagram of the system-interface plug (also shown at the lower right of FIG. 5) which involves control of the furnace or other suitable heater component to the heating system.

FIG. 7 is a schematic diagram of the user-interface plug (also shown at the lower right of FIG. 5) which involves control of components of the heating system that are located away from the furnace (such as air handlers or fans, and thermostats that control temperature in so-called zones or rooms within a recreational vehicle).

FIG. 8 is a schematic flow diagram of the controller of the present invention controlling an interconnected hydronic heating system.

### DETAILED DESCRIPTION AND BEST MODE OF THE INVENTION

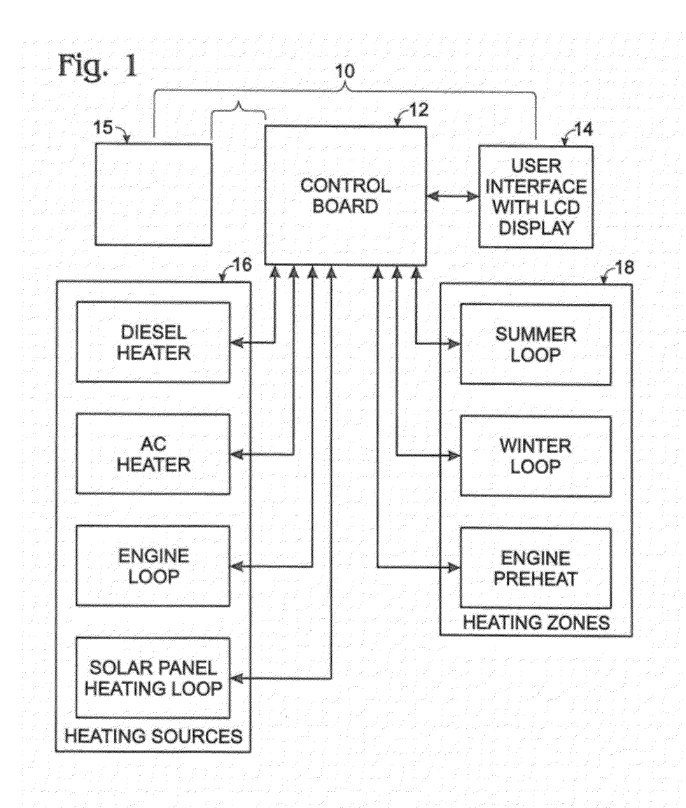

Referring to FIG. 1, a hydronic heating system including the invention is shown at 10 and includes a controller 12 (with undepicted, suitable, associated control circuitry) in bi-directional electrical/electronic communication with a user interface 14 which can be a part of controller 12 or a separate controller or control panel. User interface 14 can take the form of a display. Controller 12 can also be in fluid/plumbing communication with stand-alone subsystem (SLS) 15. Controller 12 can also be in bi-directional electrical/electronic communication with one or more heating sources 16, and with one or more heating zones 18.

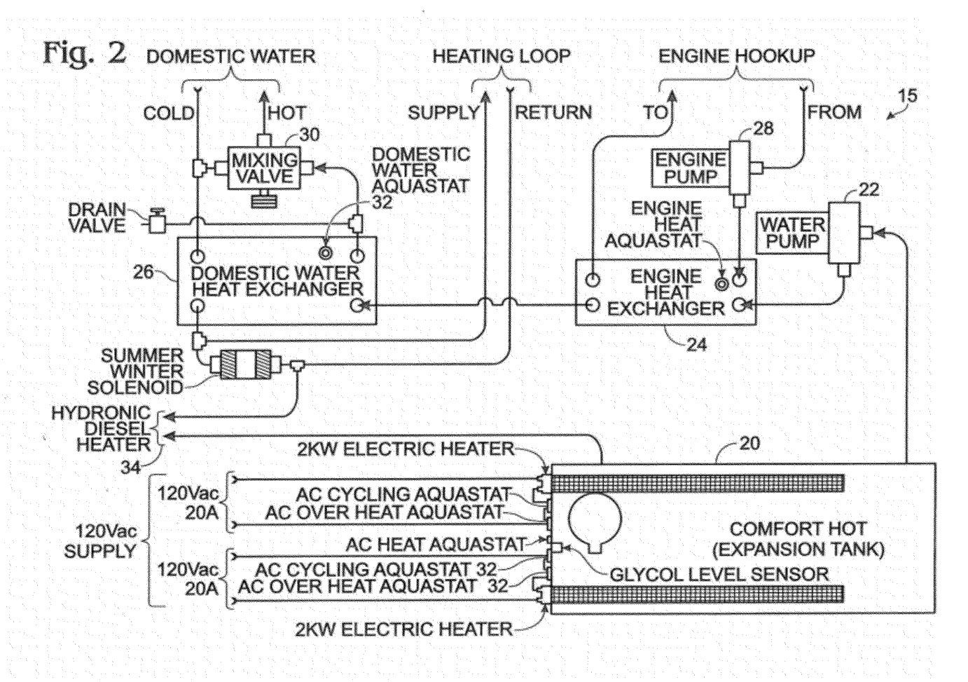

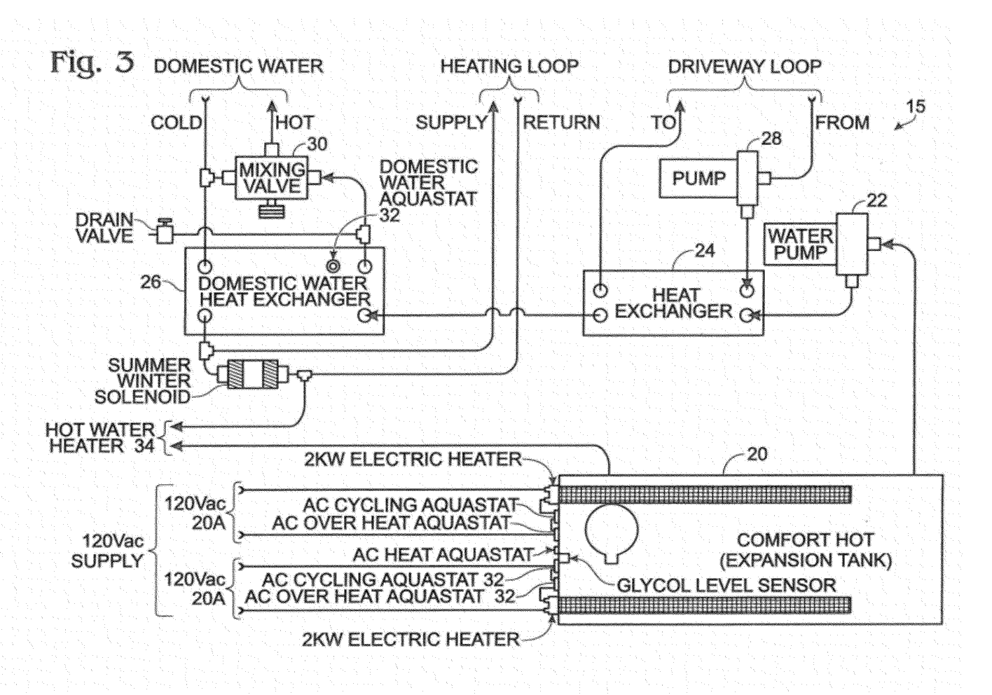

As shown best in FIGS. 2-3, each of which depict components that are coupled via fluid/plumbing connection, subsystem 15 includes a heating-solution, storage-expansion tank 20 filled with a suitable heating solution (undepicted) such as a commercial grade glycol, a water pump 22, an engine heat exchanger 24, a domestic water heat exchanger 26, a fluid pump 28 (for vehicle engine fluid in FIG. 2 and for driveway heating fluid in FIG. 3) and a mixing valve 30. Suitable temperature sensors (known commercially as aquastats or snap disk thermostats) 32 provide fluid-temperature information to controller 12 (FIG. 1) to allow the controller to make the decisions described in the above summary and in the description below. Valve 30 is preferably an anti-scald mixing valve that limits the maximum temperature of the hot water coming out the system to 130° F. The heating system may also be equipped with a check valve that eliminates the possibility that potable water stored in the holding tanks of the RV or boat could be drained by other pumping systems connected to the same water supply line.

Subsystem 15 may be provided with one or more ports 34 that allow external heating sources to be connected to the subsystem to provide supplemental heat to heat the heating solution. Referring back to FIG. 1, those external heat sources may be any conventional hydronic heating source such as a diesel heater, electric (AC) heater, a vehicle engine, or a solar panel.

Referring again to FIGS. 2-3, the subsystem 15 includes suitable, dual electric heaters (such as ones that produce 15,000 BTU/hour) and the subsystem is coupled to controller 12 (FIG. 1) with suitable control circuitry to actuate each of them. When actuated, the electric heaters are capable of heating the heating solution contained in tank 20. The subcomponents of the system that include the dual heaters and storage tank with heating solution is sold under the trademark COMFORTHOT™ by Rixens Enterprises of Oregon. For the depicted version of the system, a volume of four gallons of a commercial grade glycol is acceptable.

When the temperature sensor installed on the tank detects that the heating solution has reached 110° F.-120° F., it sends a signal to the controller 12 informing it that heat is available and usable. If one of the heating zones 18 (FIG. 1) becomes active (i.e. the user actuates the switch for heat in that one zone), the control board activates the heating-solution circulation pump, and the cabin fan or by-pass solenoid associated with the activated heating zone to allow the transfer of heat from the heating solution to the activated zone. If the heat provided by the dual electric heaters is not in sufficient supply based upon a to-be-described algorithm, the control board activates other hydronic heat sources available to the system (see box 16 of FIG. 1). For example, the system may have access via suitable heater ports to various supplemental conventional hydronic heaters such as a diesel-fired heater, hot-water heaters, etc.

There is bi-directional communication between the controller and the system heating sources via the actuators of each heating source. Each temperature sensor is mounted adjacent the region of the system where heat from the heating source is transferred to the heating solution. Information from all system temperature sensors provides the controller with necessary input about the existence of heat into the system. To ensure that the information is available to the controller, it is constructed to continuously scan associated temperature sensors of the system heating zones temperature sensors to determine when a given zone is active.

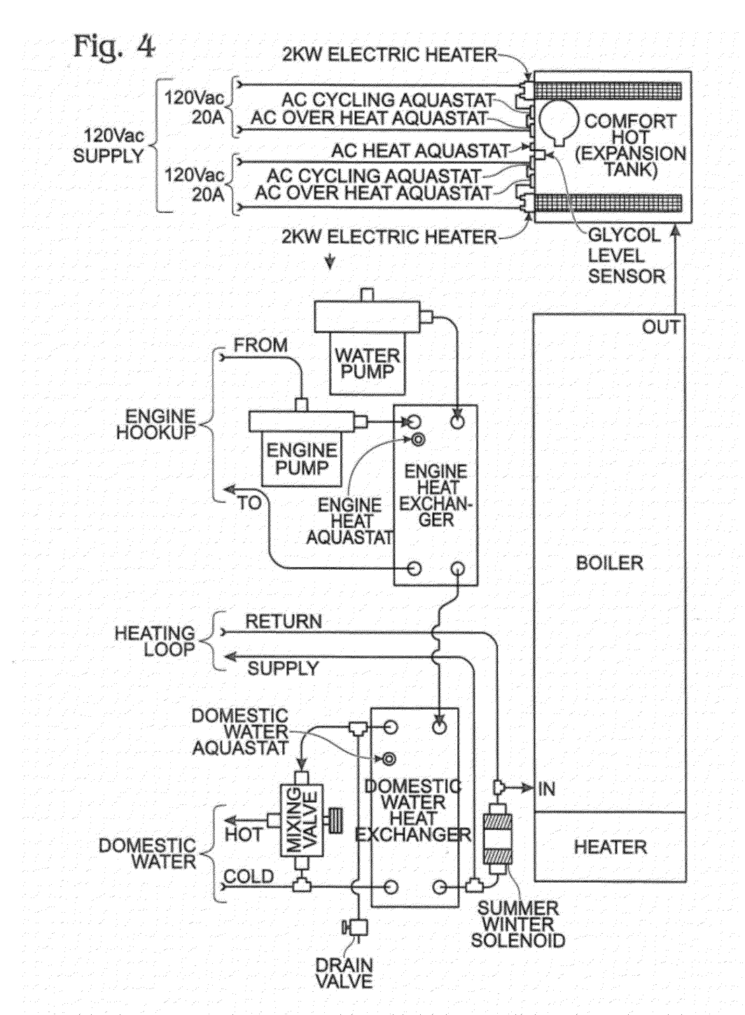

Once the two conditions are met (the controller learns that heat is available and the user requests heat by actuating a heat zone), the controller activates the heating-solution circulation pump which pumps the heating solution through preselected loops of the system because the system includes a series of heating loops. However, the transfer of heat from the heating solution will take place only where the heating zone(s) has been actuated by the user. The heat transfer is done using a combination of one or more of the following: liquid-to-liquid heat exchangers, cabin fans, or by-pass solenoids in conjunction with fine tubes (see FIG. 4).

One of the biggest advantages of the controller in combination with the heating systems described is that it makes possible the integration of an unlimited number of hydronic heating sources without restriction on size or shape. The four shown in FIG. 1 at 16 are only representative of the unlimited number of heating sources (and also unlimited number of heating zones 18) that can be coupled to system 10.

Referring to FIGS. 1-4, the heating system also includes several programmable features preferably achieved using software so that each can be adjusted without requiring new hardware, and those features include: (i) a water-heating cycling feature that maximizes the capability and efficiency of the system heat sources by using plural heating solution temperature ranges for automatic actuation/de-actuation of each system heat source depending upon whether the user demands domestic hot water (e.g. system heat source(s) are actuated if water temperature falls below 150° F. and de-actuated if heating solution temperature reaches 180° F.) or area heating (without demand for domestic hot water)(e.g. system heat source(s) are actuated if heating solution temperature falls below 120° F. and de-actuated if heating solution temperature reaches 180° F.), (ii) a heat source priority controller governing situations when different ones of the heating sources of the system are actuated depending upon pre-selected factors such as heating source availability, user-demand requirements, etc.; (iii) an engine preheat loop that allows bi-directional heat transfer from and to the engine to allow for various engine situations such as vehicle-engine applications (RV and marine) as well as home-heating engine applications affording the capability to deice a driveway; (iv) a time-based de-actuator feature that disables an engine-preheat pump after a preset period of time to avoid undesired drainage of associated engine batteries and excessive wear of the pump

Referring to FIGS. 1, and 5-8, controller 12 is constructed to direct the flow of the heating solution through plural preselected loops such as a short (e.g. summer) loop supporting demand for hot domestic water but not heat (summer applications) and a long (e.g., winter) loop supporting demand for both hot domestic water and heat (winter applications). The controller is also constructed to optimize heating efficiency and cost by having the capability of sensing whether any thermostat of the system becomes active, and responding to such sensing by activating a by-pass solenoid (that may be plural-way including two- or three-way) that allows the heating solution to circulate through the long loop.

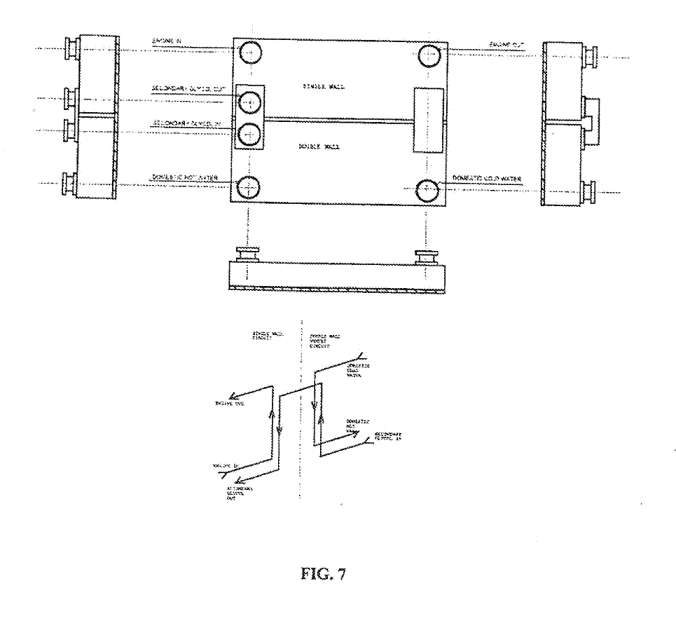

Controller 12 is also programmable for automatic actuation/de-actuation of heating-area fans (such as cabin fans shown in FIGS. 4 and 7) when system heating solution temperature is over preselected minimum such as 110° F. (actuation) or under a preselected maximum such as 110° F. (de-actuation), circulating water pumps, and for by-pass of the long loop solenoid if heat is unavailable. The system includes a set of temperature sensors that allow the control board to determine when heat is available from system heat sources and to determine when the cabin fans, circulating water pumps and by-pass solenoids are deactivated or activated.

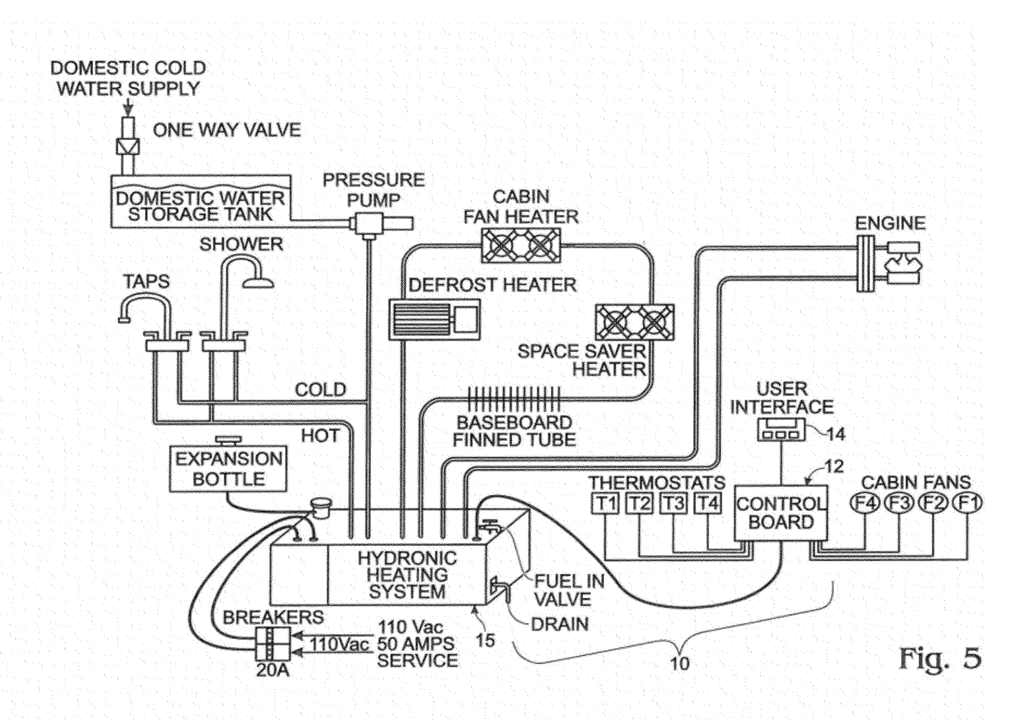

Referring to FIG. 5, there is a schematic drawing of a sheet-metal drawing for a control board cover that forms part of the controller of the present invention. By controller, applicant means the control system for the heating system. The controller includes the control board cover, container, control circuitry, suitable electrical connectors that couple the control circuitry to components of the heating system that are electrically controlled, and electrical/electronic sensors (e.g. suitable transistors) that sense whether each component of the heating system is functioning. The controller can further include software that can control the heating system and components therein. The circles in FIG. 5 depict two-color LED lights that are coupled to the cover and electrically connected to transistors located adjacent each component of the heating system. One color (e.g., green) indicator tells the user that the component is functioning properly, and the other color (e.g. red) shows the user there is a malfunction/problem with that component. The presently preferred color indicators are green for proper functioning and red for malfunction/problems with a component. For example, the control board can have six indicator green lights including heat solution 120° F. 101, furnace on 102, heater pumps on 103, fans+summer/winter on 104, engine preheat on 105, and domestic water on 106. Accordingly, for example, the control board can have eight red fault lights including fan fault 107, low voltage fault 108, low level fault 109, heater pump 1 fault, 110, heater pump 2 fault 111, summer/winter fault 112, engine preheat fault 113, and inverter fault 114.

The control board can use a 40 amp power-in connection 115 and two 18 pin amp connections—one used for a user interface 116 and one for a system interface 117. User interface 116 can include any number of connections. In one embodiment of the user interface, for example, thermostat connections T1-T5, fan connections F1-F5, heater pump connection (HTR PUMP), two ground connections (GND), two heat sensor connections (HEAT SENS) that activate fans at 120° F., one thermostat out (T-STAT OUT) connection to power T1-T5, and two domestic hot water connections (D/W AQ) to operate aqua stat mounted to a hot water tank can be included. Similarly, system interface 117 can include any number of connections. In one embodiment, for example, sixteen connections can be used for controlling a furnace (e.g. hydronic furnaces such as 55XLT and DEH 65 and other Espar™ furnaces manufactured by Espar Heating Systems of Ontario, Canada) and its components including connections for a heater pump (HTR PMP), summer/winter solenoid (S/W), engine preheat pump (ENG PUMP), two domestic water aqua stats (D/W AQ), two 24 volt outputs to the furnace (24+ OUT), heater on/off (HTR ON/OFF), pump output (PUMP OUT), heater fault code (HTR FLT), two grounds (gnd), two 120° F. heat sensors for fans (HEAT SENS), and two low level indicators (LEV).

The control board can be solid state with no moving parts. It can have six resetting fuses, fourteen indicator lights, an eight-pin modular jack, two manual switches including a pump override (e.g., prime) switch 118, which when “on” overrides all logic in the system even with power switches off, and a master (e.g., main) on/off switch 119. An eight pin phone jack (e.g., remote plug) 120 can feed a remote panel with four switches including master on, furnace on, domestic water on, and engine preheat on.

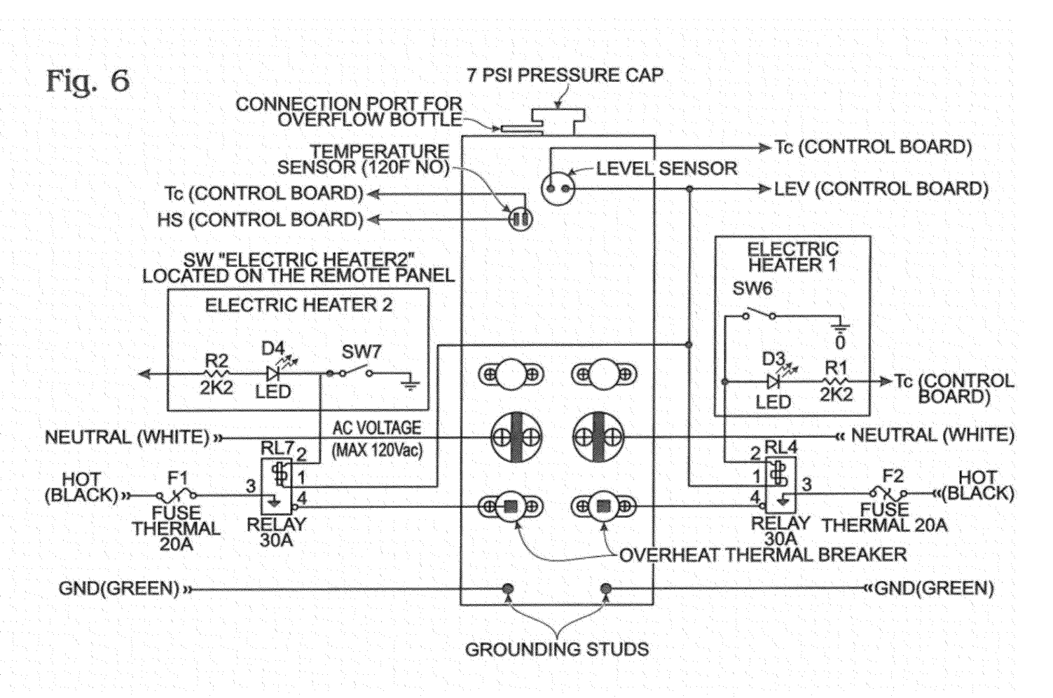

Referring to FIG. 6, the system-interface plug 117 of FIG. 5 is shown in schematic detail, with the dark, relatively wide lines depicting wire connections from the plug to each component in the heating system. The heating system is shown schematically within the rectangular section positioned vertically at the right side of FIG. 6 (when FIG. 6 is positioned so that the System Interface title is at the top of the page). The preferred heating system is sold by Rixen's Enterprises under the registered trademark QUANTUM®.

Referring to FIG. 7, the user-interface plug 116 of FIG. 5 is shown in schematic detail, with dark, relatively wide lines depicting wire connections from the plug to components of the heating system that are located away from the furnace. Examples of components located away from the furnace include cabin thermostats 701 (see lower region of FIG. 7) and air handlers or fans 702 (see top region of FIG. 7). The thermostats are located in pre-selected zones within the cabin and preferably each zone corresponds to a room or part of a room (such as a living room, kitchen, etc.). As noted to the right of FIG. 7, the heating system must be modified as described if either the main water pump cannot produce a flow rate of 2 GPM (gallons per minute) through the cabin loop. The cabin loop refers to the plumbing system that conveys water throughout the cabin in a closed loop. The heating system heats the water which is pumped via one or more pumps through the loop to provide heat as desired in the cabin. Still referring to the text at the right of FIG. 7, a relay interface must also be used if the fans and pumps of the heating system draw more than 5 amperes (amps). FIG. 7 provides at the lower right, a proposed relay for a situation where the fans and pumps draw more than 5 amps.

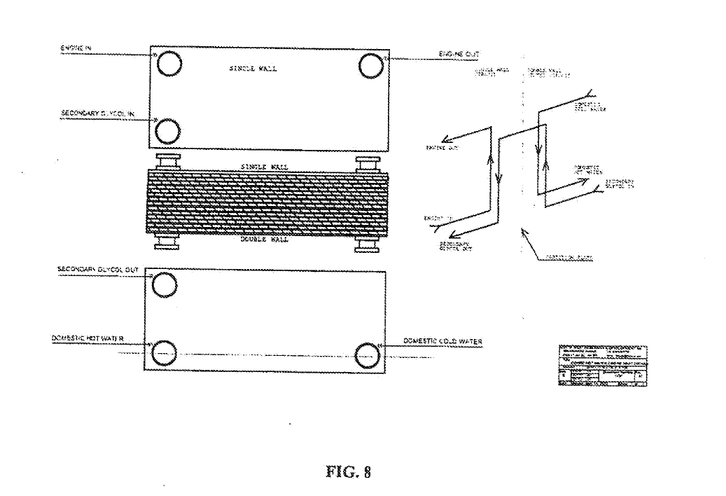

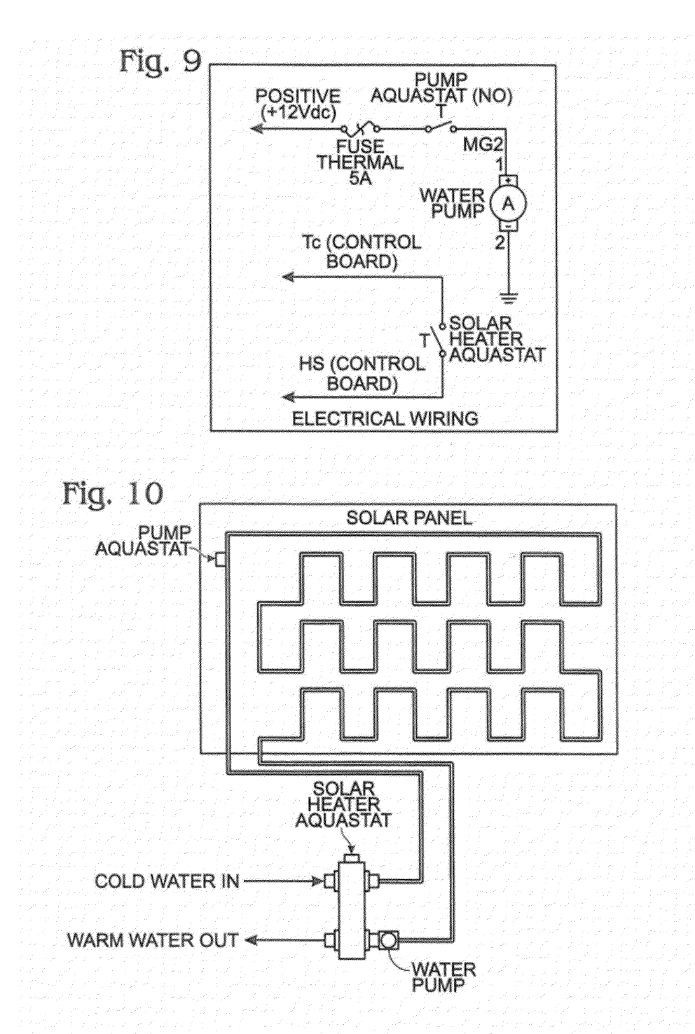

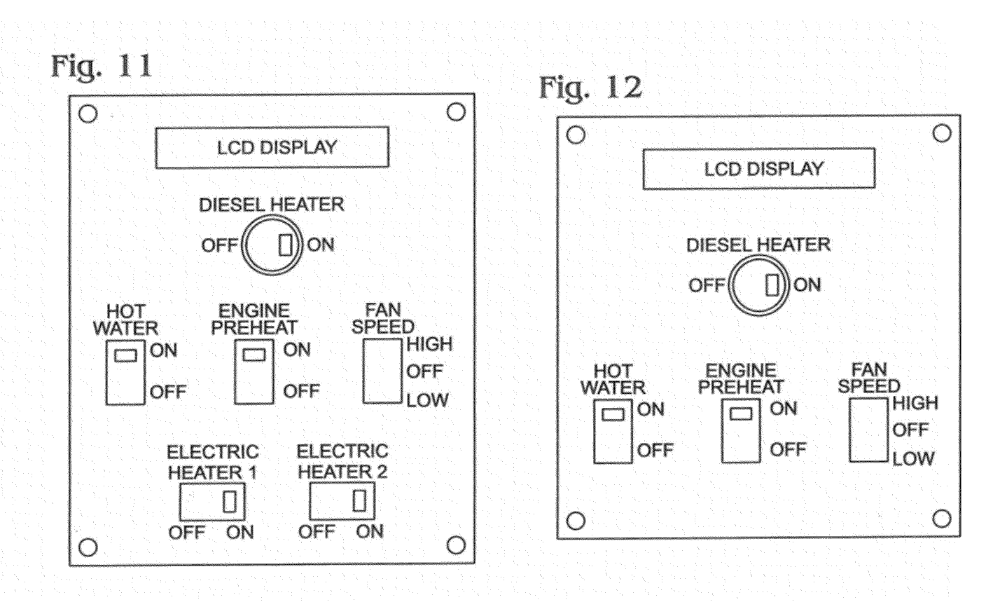

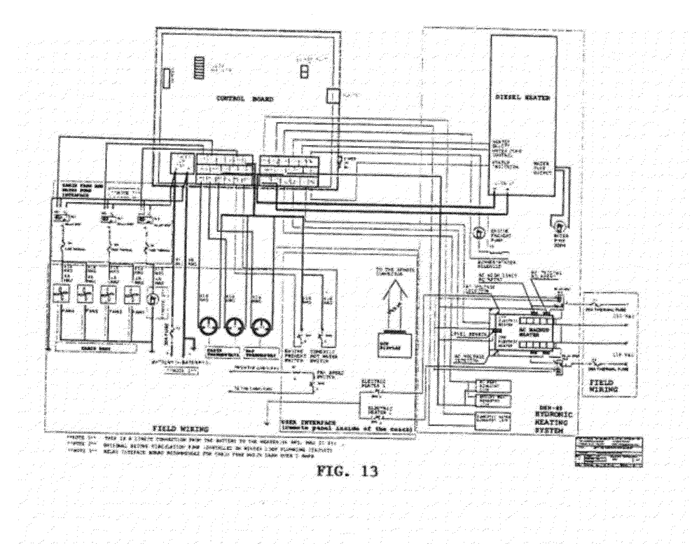

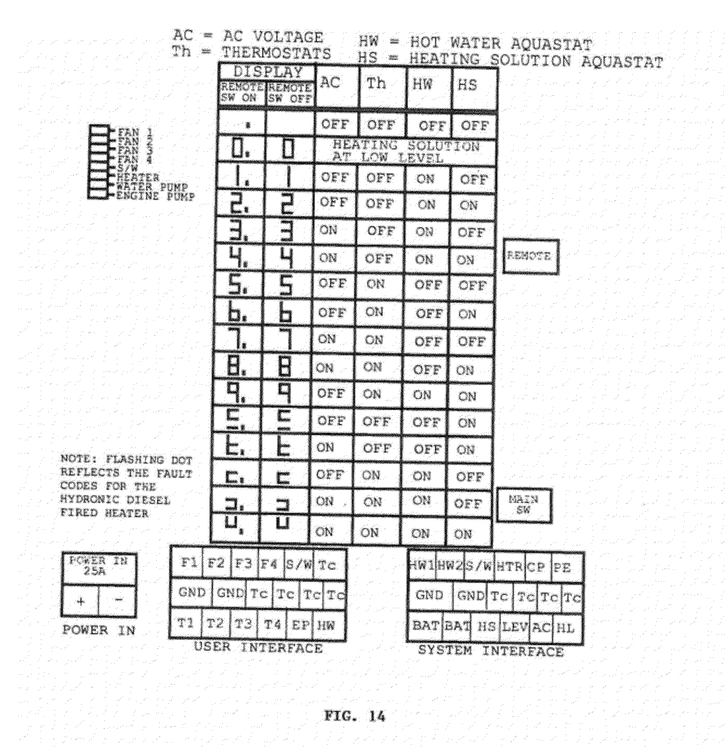

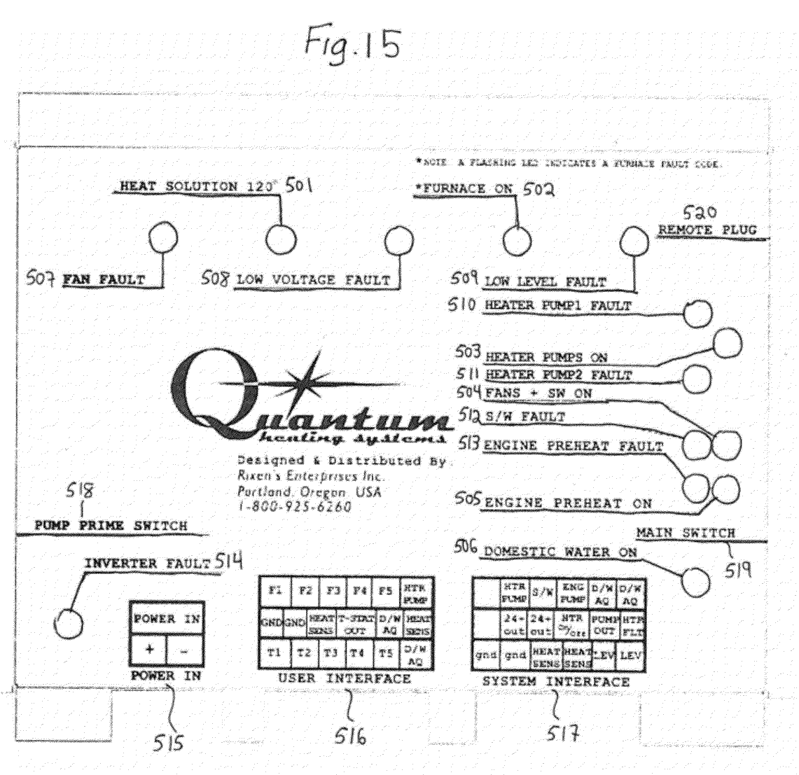

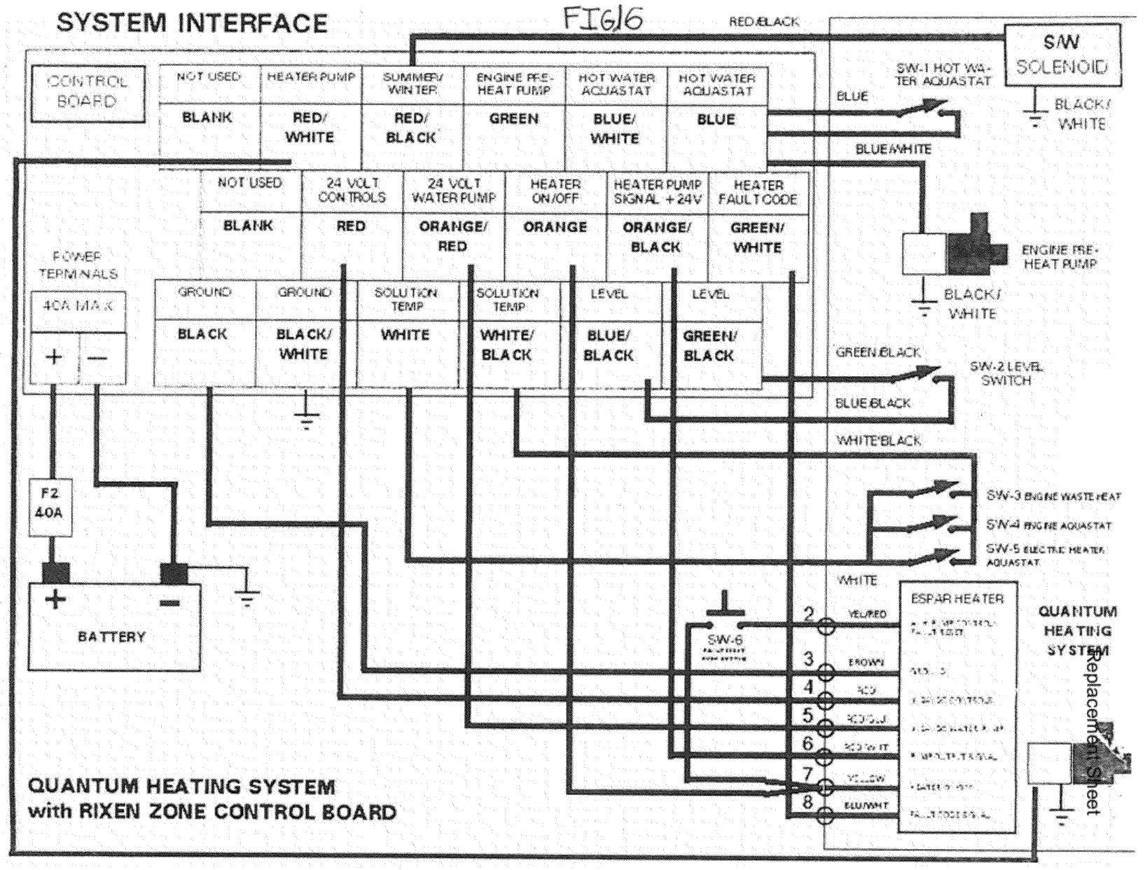

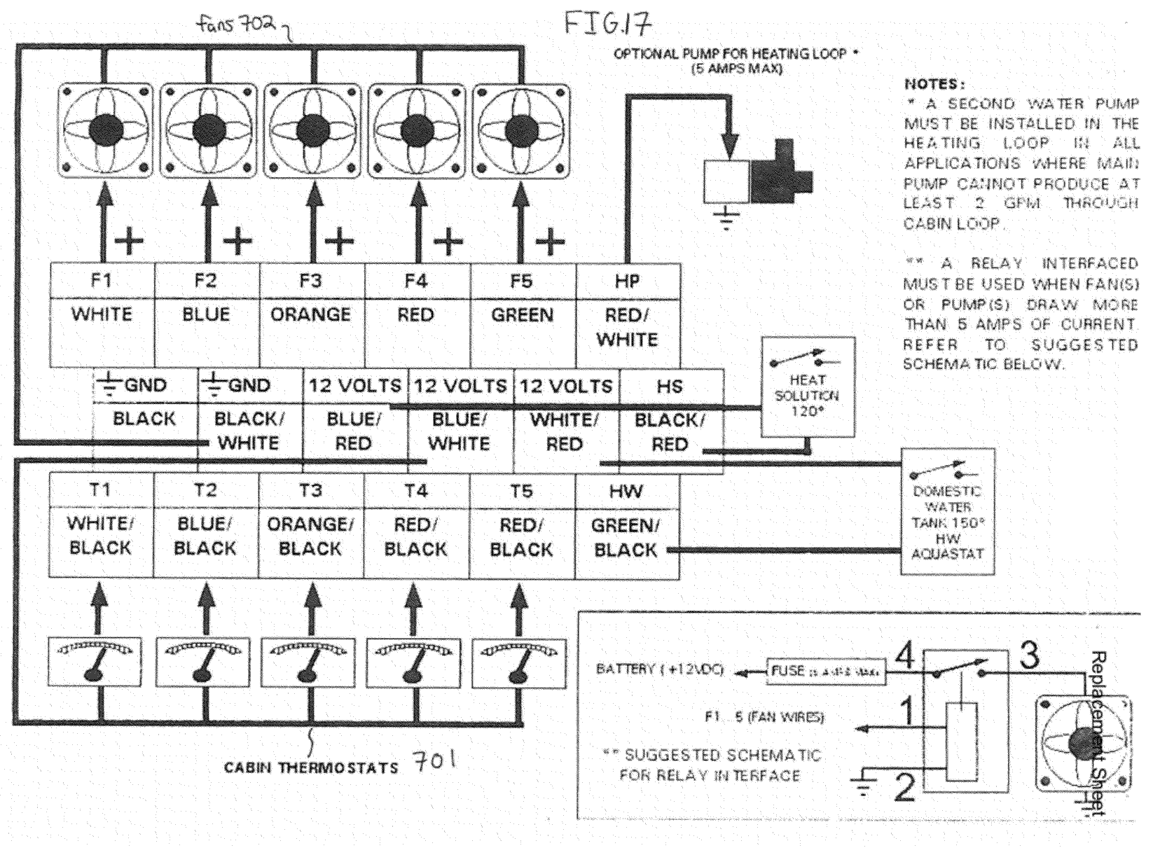

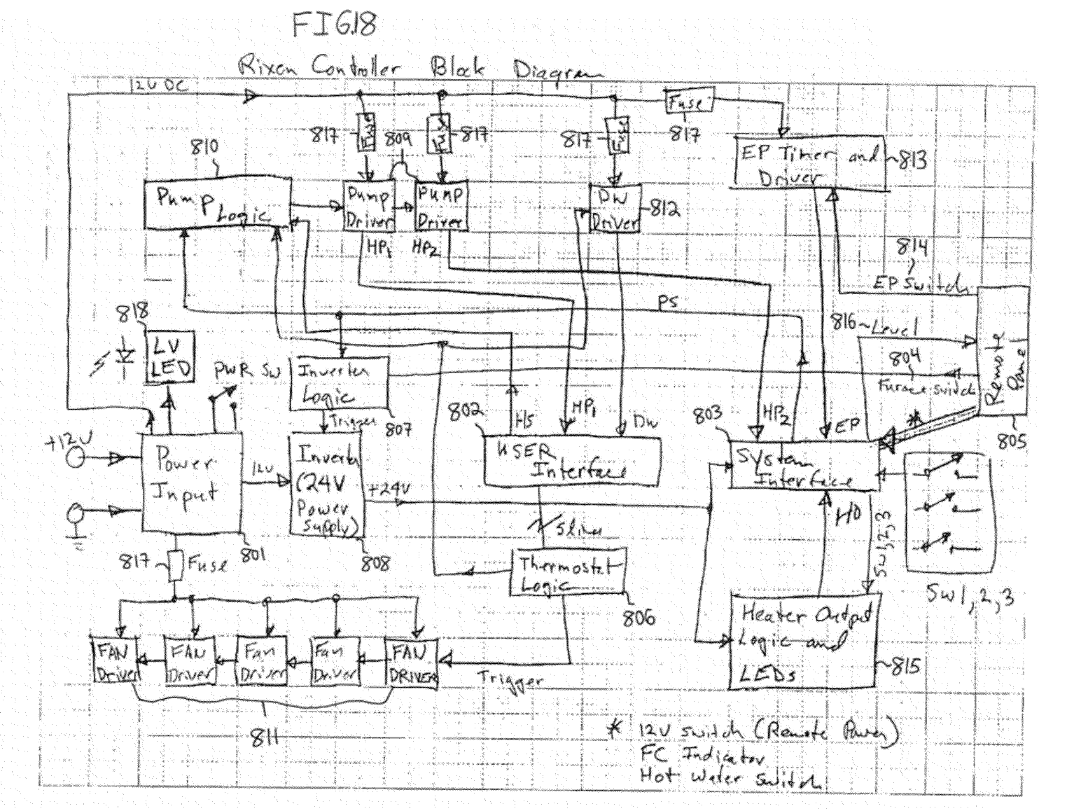

Referring to FIG. 8, an exemplary implementation of the controller described herein interacting with a controller is shown in block diagram schematic detail. Power input 515 of FIG. 5 is shown at 801 and provides 12 volt remote power to the system. Both master switches can be turned on so that the system is energized. User interface 516 of FIG. 5 is shown at 802 and system interface 517 of FIG. 5 is shown at 803. To fire the heating system, the diesel furnace switch 804 on the remote panel 805 must be in the “on” position and there must be a call for heat from thermostat logic 806 (via a thermostat) or domestic water heater logic (via an Aqua Stat attached to a hot water heater) not shown.

In the exemplary embodiment, five thermostat inputs plus an optional sixth are on the controller. Each thermostat controls a heater fan (controlled by heater drivers 811) with a circuit configuration to minimize false thermostat readings, such as AC noise. When the remote furnace switch 804 is triggered, a signal is sent to inverter logic 807 which instructs internal power inverter (24 volt power supply) 808 to provide 24 volt power to the furnace and furnace pump drivers HP1 and HP2 shown by 809. The furnace power supply signal is represented by PS in the diagram. The furnace pump must run when the furnace is running The furnace pump can also run independently of the furnace when the heating solution is greater than 120° F., as a means for distributing heat without further heating the solution in the furnace. Pump drivers 809 can be under the control of pump logic 810 through which the incoming signals to pump drivers 809 flow. Pump logic 810 can be activated by prime switch override (518 of FIG. 5), remote panel furnace switch 804 (unless overridden by low solution level signal 816 or insufficient voltage), or the furnace power supply signal (PS). The system sends power to one or more fan drivers 811 when the heating solution temperature is above 120° F. and the pump driver HP1 is running and heat is called for at the location that the one or more fan drivers supplies. If the furnace faults, it sends a fault code to the control board which is read by a blinking light at the remote diesel furnace on switch and the furnace on switch at the control board.

The heating system can also be fired when the domestic water aqua stat, which is mounted to the hot water tank, calls for heat. The aqua stat fires the furnace when it is mounted to the domestic water heat exchanger that is built into a hydronic furnaces (e.g a DEH65 model) and utilizes domestic water (DW) heater driver 812. When the system is operating properly, the control board will show green lights. When the system is not operating properly, the control board will show red lights. The fault code light for the furnace is a green blinking light on the control board and a red blinking light on the control switch. The remote panel has a red “on” light for each switch.

A separate engine preheat loop can also be incorporated into the heating system and directed by the controller. The engine preheat function on the controller operates the engine preheat pump mounted to an engine (not shown), runs on a 15-minute timer via an EP Timer and Driver 813, and can be reset by turning the engine preheat (EP) switch 814 on the remote panel off and back on. System interface 803 is receiving input from various components of the heating system and sending information to heater output logic 815 and LEDs via switches (shown by SW 1, 2, 3). Heater output logic 815 processes the information received and sends out signals (represented by HO) to control the heating system.

Control board dimensions can be 6¼ inches long, 4½ inches high and 1½ inches deep or any other size as appropriate. Various fuses or similar devices can be utilized throughout the heating and control system to provide circuit protection and/or monitor proper functionality and voltage/communication and determine where faults occur when they might happen. Circuit protections can include internal self re-setting fuses (817) with LED indicators when open on critical power circuits, sensitive transistors can have static input, and there can be limited reverse polarity protection. Another safeguard in the controller that can be used is a low voltage warning 818 that simply activates a red (or other color) LED when there is low voltage. Various heating solution temperature cutoffs can be utilized, for example 125° F. in lieu of the 120° F. noted in the example above.

The disclosure set forth above encompasses multiple distinct inventions with independent utility. While each of these inventions has been disclosed in its preferred form, the specific embodiments thereof, as disclosed and illustrated herein, are not to be considered in a limiting sense as numerous variations are possible. The subject matter of the inventions includes all novel and non-obvious combinations and sub-combinations of the various elements, features, functions and/or properties disclosed herein.

We claim:

1. A control system for controlling a hydronic heat management system, wherein the hydronic heat management system includes at least a supply of heating solution, a short heating loop through which the heating solution can be directed through to support demand for hot domestic water but not heat, and a long heating loop through which the heating solution can be directing through to support demand for both hot domestic water and heat, the control system comprising:
a controller in bi-directional communication with the hydronic heat management system and operable to instruct the heat management system to direct the heating solution through at least one of the short and long heating loops.

2. The control system of claim 1 wherein the controller can instruct the system to heat based upon whether the temperature of the heating solution is above a preselected threshold.

3. The control system of claim 1 wherein the controller is in communication with a user interface that allows the user to be informed about the status of the system.

4. The control system of claim 1 wherein the hydronic heat management system further includes plural hydronic heating sources to supply supplemental heat and wherein the controller is coupled to the system for remote positioning therefrom and equipped with actuators necessary for controlling all heat sources of the system.

5. The control system of claim 4 wherein the controller includes user-status structure with an detector to inform the user about the status of heat sources of the system.

6. The control system of claim 4 wherein the controller includes user-status structure with displayable refill- and service-warning indicators to inform the user if one of the system fluids needs to be refilled or if the system requires service.

7. The control system of claim 6 wherein the controller determines whether the system requires service based upon preselected criteria including the passage of time, and fault detection of a system components.

8. The control system of claim 5 wherein the controller includes user-status structure with displayable refill- and service-warning indicators to inform the user if one of the system fluids needs to be refilled or if the system requires service.

9. The control system of claim 8 wherein the controller determines whether the system requires service based upon preselected criteria including the passage of time, and fault detection of a system components.

10. The control system of claim 4 wherein the controller further includes independent controls for each heat source of the system.

11. The control system of claim 4 wherein the controller further includes a text-display capability for displaying messages informing the user about the status of components of the system including the heating sources, temperature of the heating solution, and temperature of the hot water.

12. The control system of claim 11 wherein the hydronic heat management system further includes plural heating-zone fans located adjacent each heating loop, and wherein the text-display capability can inform the user about the status of each of the heating-zone fans.

13. The control system of claim 4 wherein the controller further includes user-status/communication structure for displaying fault codes associated with each heat source of the hydronic heat management system.

14. The control system of claim 13 wherein the user-status/communication structure can display fault codes both as a flashing LED display coupled to the actuator of each heat source, and as a textual message displayable on the controller.

15. The control system of claim 4 wherein the hydronic heat management system further includes fluid-level sensors that monitor the fluid level of the heating solution and provide information to the controller that allows the controller to stop all system heating sources if the fluid level of the heating solution falls below a preselected threshold.

16. The control system of claim 4 wherein the controller includes a program that has a water-heating cycling feature to maximize the capability and efficiency of the hydronic heating system heat sources by using plural heating solution temperature ranges for automatic actuation and de-actuation of each system heat source depending upon whether a user demands domestic hot water or demands that a desired heating zone be heated.

17. The control system of claim 16 wherein the program uses the following heating solution temperature range if the user demands domestic hot water: hydronic heating system heating sources are actuated if heating solution temperature falls below 150° F. and de-actuated if heating solution temperature reaches 180° F.

18. The control system of claim 17 wherein the program uses the following heating solution temperature range if the user demands that a desired heating zone be heated: system heating sources are actuated if heating solution temperature falls below 120° F. and de-actuated if heating solution temperature reaches 180° F.

19. The control system of claim 4, wherein the controller includes a heat-source-priority subcontroller governing situations when different ones of the heating sources of the hydronic heating system are actuated depending upon pre-selected factors such as heating source availability and user-demand requirements.

20. The control system of claim 1, wherein the hydronic heating system is coupled to a vehicle engine, and the hydronic heating system further includes an engine-preheat loop that allows bi-directional heat transfer from and to the vehicle engine, and wherein the control system is in bi-directional communication with the vehicle engine.

21. The control system of claim 1, wherein the hydronic heating system is coupled to a residential home heating source, and the hydronic heating system further includes an underground-driveway-heating loop that allows bi-directional heat transfer from and to the ground underneath the driveway so that the user can de-ice the driveway, and wherein the control system is in bi-directional communication with the residential home heating source to regulate the underground-driveway heating loop temperature.

22. The control system of claim 12 wherein the controller is programmable for automatic actuation/de-actuation of the heating-zone fans when system heating solution temperature is over a preselected minimum temperature or under a preselected maximum temperature.

23. The control system of claim 22 wherein the preselected minimum temperature is 110° F., at which temperature the controller actuates the heating zone fans, and wherein the preselected maximum temperature is 150° F., at which temperature the control structure de-actuates the heating-zone fans.

24. A method of managing delivery of heat to plural desired outputs, comprising:
providing an interconnected hydronic heating system with plural temperature sensors and plural desired outputs;
controlling actuation of heat in response to temperature information received from the system; and
sending heat to one of the plural desired outputs.

25. The method of claim 24 wherein the act of controlling actuation of heat in response to temperature information received from the system comprises instructing the hydronic heating system to direct a heating solution through at least one of a short heating loop and a long heating loop.

26. The method of claim 25 wherein the act of sending heat to one of the plural desired outputs comprises directing the heating solution through at least one of the short heating loop and the long heating loop.

27. One or more computer-readable media comprising computer executable instructions for performing the method of claim 25.

28. A system for managing heat distribution in a hydronic heating system, wherein the hydronic heating system includes at least a supply of heating solution, a short heating loop through which the heating solution can be directed through to support demand for hot domestic water but not heat, and a long heating loop through which the heating solution can be directing through to support demand for both hot domestic water and heat, the control system comprising:
means for communicating with the hydronic heating system;
means for instructing the hydronic heating system to direct the heating solution through at least one of the short and long heating loops.

29. The system of claim 28 wherein the means for instructing can instruct the hydronic heating system to heat based upon whether the temperature of the heating solution is above a preselected threshold.

30. The system of claim 28 wherein the means for communicating is in communication with a user interface that allows a user to be informed about the status of the system.
